(19) United States
(12) Patent Application Publication
(10) Pub. No.: US 2008/0122712 A1
(43) Pub. Date: May 29, 2008

(54) TUNABLE ANTENNA INCLUDING TUNABLE CAPACITOR INSERTED INSIDE THE ANTENNA

(75) Inventor: Lee-Yin V. Chen, Goleta, CA (US)

Correspondence Address: FENWICK & WEST LLP, SILICON VALLEY CENTER, 801 CALIFORNIA STREET, MOUNTAIN VIEW, CA, 94041, US

(73) Assignee: Agile RF, Inc., Goleta, CA (US)

(21) Appl. No.: 11/943,511

(22) Filed: Nov. 20, 2007

Related U.S. Application Data
(60) Provisional application No. 60/867,481, filed on Nov. 28, 2006.

(51) Int. Cl. H01Q 9/00

(52) U.S. Cl. 343/745

(57) ABSTRACT

A tunable component such as a tunable BST (Barium Strontium Titanate) capacitor is added inside the antenna structure, and the input impedance of the antenna is tuned by tuning this tunable component, rather than adding a multiple-component impedance matching network at the feed point of the antenna outside the antenna as in conventional solutions. With this structure, the input impedance of the antenna may be adjusted very precisely and efficiently.

### CROSS-REFERENCE TO RELATED APPLICATION

This application claims priority under 35 U.S.C. §119(e) from co-pending U.S. Provisional Patent Application No. 60/867,481, entitled “Tunable Antenna Including Tunable Capacitor Inserted In Series Inside The Antenna” filed on Nov. 28, 2006, which is incorporated by reference herein in its entirety.

### BACKGROUND OF THE INVENTION

1. Field of the Invention

The present invention relates to an antenna and, more specifically, to tuning the impedance of an antenna.

2. Description of the Related Art

Antennas are used to radiate or receive radio frequency (RF) signals. The impedance of an antenna can typically be modeled as a resonance circuit at the feed point of an antenna. Some antennas are designed so that the impedance at the feed point is matched to the circuitry connected to the feed point of the antenna at the desired operating frequency. Other antennas require matching networks to tune the impedance of the antenna to the desired value, so that the impedance is matched between the antenna and the RF circuitry connected to the feed point of the antenna and power is transmitted or received with optimal efficiency. The RF circuitry connected to the antenna sends or receives an RF signal to or from the antenna.

A conventional way of changing the impedance of an antenna is to add an impedance matching network at the feed point of the antenna outside the antenna. To design a tunable antenna, multiple tunable components are included in the impedance matching network (tunable matching network) added to the feed point of the antenna. However, such conventional solution is limited to the antenna's impedance and may not result in high efficiency antennas, when multiple components are used in the impedance matching network. The multiple components of the impedance matching network add more loss to the overall antenna system. Also, adding an impedance matching network to only the feed point of the antenna does not provide the flexibility needed in antenna design.

Therefore, there is a need for a more effective technique for tuning the impedance of an antenna.

### SUMMARY OF THE INVENTION

A tunable component such as a tunable capacitor is inserted inside the antenna structure and the impedance of the antenna is tuned by tuning this tunable component, rather than adding a multiple-component matching network at the feed point outside of the antenna as in conventional solutions. More specifically, embodiments of the present invention include an antenna comprising an antenna structure for radiation and reception of a radio frequency signal, and a tunable capacitor inserted in the antenna structure. The capacitance of the tunable capacitor is tunable to adjust an input impedance of the antenna. In one embodiment, the tunable capacitor is a BST capacitor including BST (Barium Strontium Titanate) dielectric, and the capacitance of the BST tunable capacitor is tunable by adjusting a DC bias voltage applied to the BST dielectric.

The tunable capacitor may be inserted in the antenna structure in a variety of locations. In one embodiment, the tunable capacitor is placed in the antenna structure away from both ends of the antenna structure. In another embodiment, the antenna structure includes a first part, a second part, and a third part, where the first part of the antenna structure is adjacent to a feed point of the radio frequency signal to the antenna, the second part of the antenna structure includes the tunable capacitor placed therein, and the third part of the antenna structure includes one end coupled to both the first part of the antenna structure and the second part of the antenna structure and another end coupled to ground.

The antenna of the present invention has the advantage that the input impedance of the antenna may be adjusted precisely and efficiently. The added tunable component does not change the antenna's radiation pattern or directivity. The efficiency of the antenna is improved because the impedance match is better. Also, the tunable component can be added to a variety of locations in the antenna, providing flexibility in the design of the antenna. The present invention can also be used in other antennas that require frequency tuning or impedance tuning.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates an example of a conventional series resonance circuit together with its Smith Chart.

FIG. 2 illustrates a simple, conventional antenna.

FIG. 3 illustrates a conventional antenna with a tunable capacitor added at the feed point of the antenna and its equivalent circuit.

FIG. 4 illustrates an antenna with a tunable capacitor added inside the antenna and its equivalent circuit, according to one embodiment of the present invention.

FIG. 5 illustrates a conventional antenna that is connected to ground.

FIG. 6 illustrates a tunable capacitor added inside the antenna of FIG. 5 connected to ground, according to another embodiment of the present invention.

FIG. 7 illustrates a typical metal-insulator-metal (MIM) parallel plate configuration of a thin film BST capacitor according to one embodiment of the present invention.

FIG. 8A is a graph illustrating a typical tuning curve for the BST capacitor of FIG. 7.

FIG. 8B is an equivalent circuit model for the BST capacitor of FIG. 7.

FIG. 9 illustrates the tuning range of the antenna of FIG. 4.

FIG. 10 illustrates the tuning range of the antenna of FIG. 6.

FIG. 11 illustrates a conventional multiple component matching network inserted at the feed point of the antenna of FIG. 5.

FIG. 12 illustrates the tuning range of the antenna of FIG. 11.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

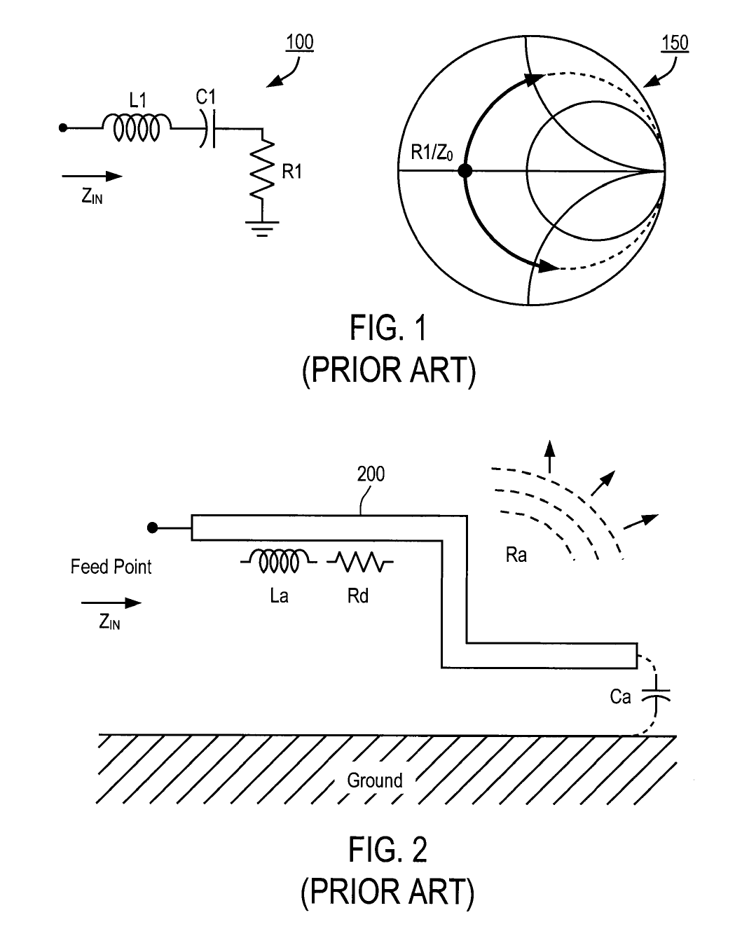

FIG. 1 illustrates an example of a conventional series resonance circuit 100 together with its associated Smith Chart 150. Referring to FIG. 1, the series resonant circuit 100 comprises an inductor L1, a capacitor C1, and a resistor R1. Note that the locations of all series components are interchangeable in the series resonant circuit. If the resistance R1 is fixed, the input impedance Z_{IN} of the series resonant circuit 100 would be on the R1/Z₀Ω circle of the Smith Chart 150 at all frequencies, regardless of the values of inductor L1 and the capacitor C1. Z₀ is the impedance to which the Smith Chart is normalized. The best impedance match to the normalized impedance Z₀ occurs at the resonance frequency,

$$\frac{1}{2 π \sqrt{{L}_{1} {C}_{1}}} .$$

### Hence, the best impedance match frequency can be changed by changing the value of either inductor L1 or capacitor C1.

FIG. 2 illustrates a simple, generic antenna 200. The antenna 200 is typically comprised of an antenna structure that is a piece of metal line, which can be simply modeled as an inductor La in series with a resistor Rd. The resistor Rd models the loss in the antenna structure. Additionally, the antenna 200 is associated with the fringe capacitance Ca, which is the fringe capacitance of the antenna structure metal to ground, and the radiation resistance Ra of the antenna 200. At the feed point of the antenna 200, the input impedance (Z_{IN}) of the antenna 200 can be modeled as a series resonance circuit such as that shown in FIG. 1, with L1=La, C1=Ca, and R1=Rd+Ra. Such an antenna may be a very narrow band antenna.

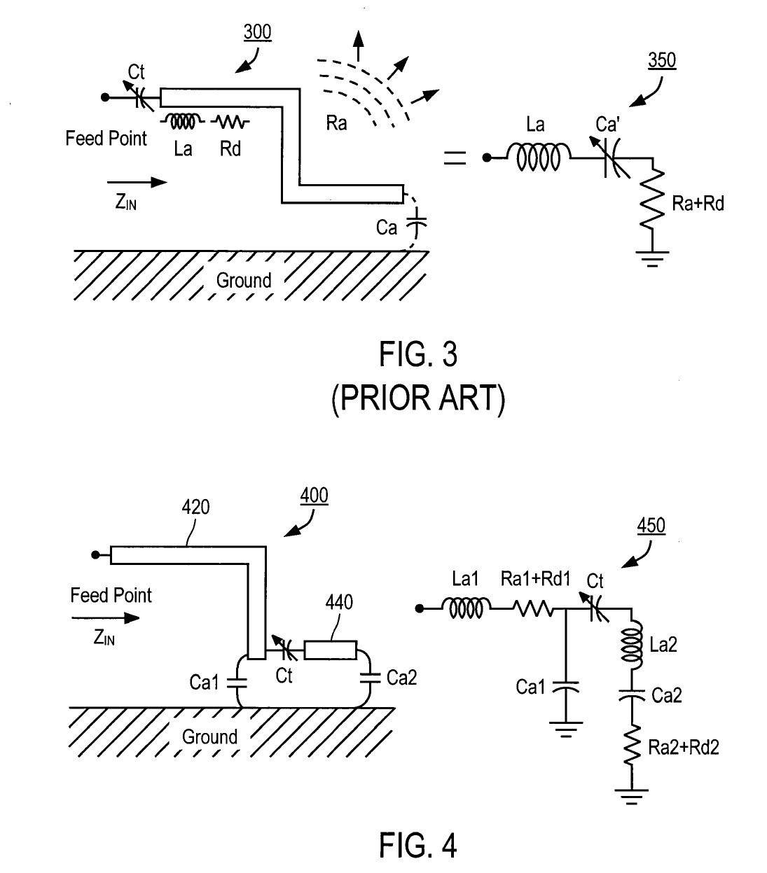

FIG. 3 shows a conventional antenna 300 with a tunable capacitor Ct added adjacent to the feed point of the antenna, and its equivalent circuit 350, according to one embodiment of the present invention. As shown in FIG. 3, the equivalent circuit 350 of the antenna 300 can be represented by the inductance La, the equivalent capacitance Ca′ combining the tunable capacitor Ct and the fringe capacitance Ca, and the combined resistance Ra, Rd, all coupled in series to each other. Here, the capacitance Ca′ in the equivalent circuit of the antenna is as follows:

$${C}_{a}^{′} = \frac{{C}_{a} {C}_{t}}{{C}_{a} + {C}_{t}} .$$

### Thus, the input impedance Z_{IN} of the antenna 300 can be adjusted by change the capacitance value of the tunable capacitor Ct.

The tuning range of the antenna of FIG. 3 is mainly determined by the tunability τ of the tunable capacitor Ct. For a tunable capacitor Ct with tunability τ, defined by

$$τ = \frac{{C}_{max}}{{C}_{min}}$$

where Cₘₐₓ is the maximum capacitance of the tunable capacitor Ct and Cₘᵢₙ is the minimum capacitance of the tunable capacitor Ct, the frequency tuning range (fₘₐₓ/fₘᵢₙ) of the tunable antenna 300 is determined by the following equation:

$$\frac{{f}_{max}}{{f}_{min}} = \sqrt{τ \frac{{C}_{a} + {C}_{min}}{{C}_{a} + τ {C}_{min}}} ,$$

where fₘₐₓ is the maximum resonant frequency to which the antenna 300 can be tuned and fₘᵢₙ is the minimum resonant frequency to which the antenna 300 can be tuned. The input impedance of the antenna 300 may be adjusted simply by adjusting the capacitance of the tunable capacitor Ct. The above equation also shows that, by adjusting the fringe capacitance Ca, a wider frequency range for the antenna can be achieved. This is advantageous because the fringe capacitance Ca can be adjusted by simply adjusting the distance to the ground plane slightly, maintaining the major property of the antenna (such as radiation pattern, directivity, etc.) without changing the fundamental design of the structure of the antenna.

FIG. 4 shows an antenna with a tunable capacitor Ct added inside the antenna and its equivalent circuit, according to another embodiment of the present invention. The tunable capacitor Ct can be, for example, a BST capacitor using BST (Barium Strontium Titanate) as the dielectric of the capacitor, although other types of tunable capacitors may be used with the tunable antenna of the present invention. When the tunable capacitor Ct is a BST capacitor, the tunability τ of the tunable capacitor Ct is determined by the tunability of the BST dielectric, the thickness of the BST dielectric, the size and dimension of the metal electrodes of the BST capacitor, and other factors.

The tunable capacitor Ct can be inserted anywhere along the metal line antenna structure of the antenna 400, with the possibility of reducing the tuning range. In FIG. 4, the tunable capacitor Ct is inserted inside the antenna 400 at a location away from the two ends of the antenna 400. Physically, the tunable capacitor Ct can be added by simply dividing the antenna 400 into two physical sections 420, 440, and electrically connecting the tunable capacitor Ct between the two sections 420, 440. The tunable capacitor Ct in FIG. 4 divides the antenna 400 into two parts 420, 440, and the equivalent circuit 450 of the antenna 400 becomes more complicated. For the first part 420 of the antenna 400, La1 is the series inductance, Ca1 is the fringe capacitance to ground, Ra1 is the radiation resistance, and Rd1 is the loss resistance. For the second part 440 of the antenna 400, Ca2 is the fringe capacitance to ground, Ra2 is the radiation resistance, and Rd2 is the loss resistance. If the antenna structure is large compared to the wavelength, a transmission-line model can be used for more precise modeling of the antenna. The resulting equivalent circuit 450 of the antenna 400 includes the inductance La1 coupled in series to the combined resistance of Ra1, Rd1 of the first part 420 of the antenna, which are coupled to two branches in the equivalent circuit. The capacitance Ca1 forms one branch. The tunable capacitor Ct, the inductance La2, the capacitance Ca2, and the combined resistance Ra2, Rd2 are connected in series to form the other branch.

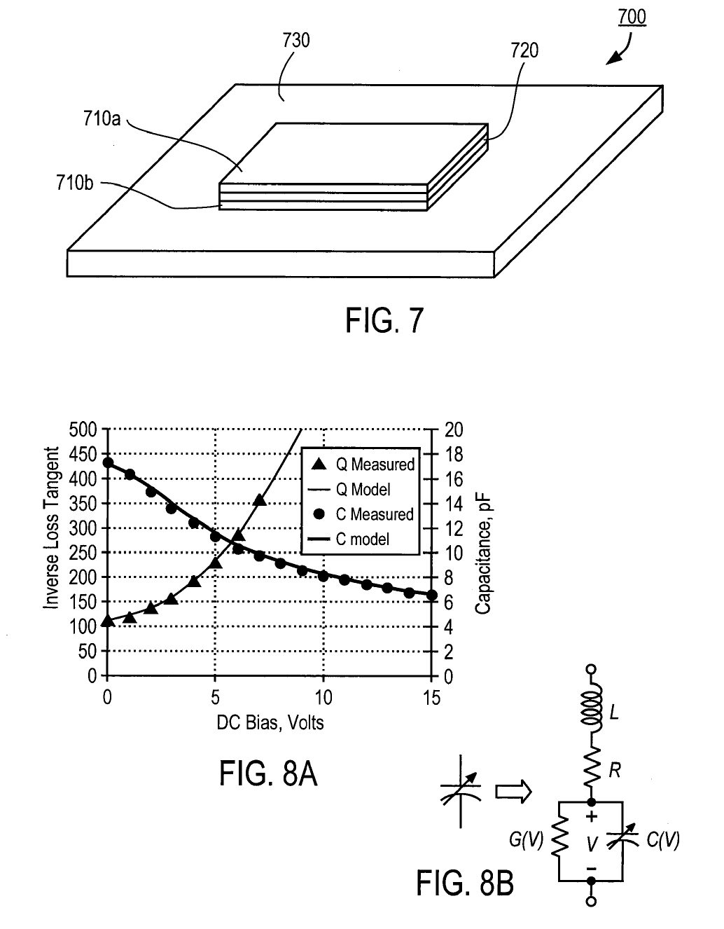

FIG. 7 illustrates a typical metal-insulator-metal (MIM) parallel plate configuration of a thin film BST capacitor according to one embodiment of the present invention. Such BST capacitor may be used as the tunable capacitor Ct in FIG. 4. Referring to FIG. 7, the capacitor 700 is formed as a vertical stack comprised of a metal base electrode 710b supported by a substrate 730, BST dielectric 720, and a metal top electrode 710a. The lateral dimensions, along with the thickness of the BST dielectric 720, determine the capacitance value of the BST capacitor 700.

BST generally has a high dielectric constant so that large capacitances can be realized in a relatively small area. Furthermore, BST has a permittivity that depends on the applied electric field. As a result, voltage-variable capacitors (varactors) can be produced, with the added flexibility that their capacitance can be tuned by changing a DC bias voltage across the BST capacitor. Thus, the input impedance of the antenna 400 in FIG. 4 may be adjusted simply by adjusting the DC bias voltage applied to the tunable BST capacitor Ct, which in turn changes the capacitance of the BST capacitor. In addition, the bias voltage of the BST capacitor can be applied in either direction across a BST capacitor since the film permittivity is generally symmetric about zero bias. That is, BST does not exhibit a preferred direction for the electric field. One further advantage is that the electrical currents that flow through BST capacitors are relatively small compared to other types of semiconductor varactors.

FIG. 8A is a graph illustrating a typical tuning curve for the BST capacitor 700. FIG. 8A shows the dependence of both capacitance and dielectric loss (inverse loss tangent) of the BST capacitor 700 upon the DC bias voltage applied to the BST capacitor 700. As shown in FIG. 8A, the capacitance (C) of the BST capacitor 700 decreases from approximately 16.5 pF to approximately 6 pF as the DC bias voltage applied to the BST capacitor 700 varies from 0 volt to 15 volt. Also, the inverse of the loss tangent (i.e., Q_{BST}=1/tan δ) is greater than 100. Thus, the capacitance of the BST capacitor 700 can be tuned by simply changing the applied DC bias voltage.

FIG. 8B is an equivalent circuit model for the BST capacitor of FIG. 7. The model in FIG. 8B captures the loss elements and the large signal properties of the BST capacitor 700. The material non-linearities are described by the parallel combination of the conductance G(V) and the capacitance C(V). An empirical model that adequately defines the C-V and Q-V tuning curves of FIG. 8A is given by:

$$C ( V ) = \frac{{C}_{0}}{\sqrt[3]{1 + {( V / {V}_{m} )}^{2}}}$$

$$G ( V ) = \frac{ω C ( V )}{{Q}_{BST} ( V )}$$

$${Q}_{BST} ( V ) = \frac{1}{tan δ} = {Q}_{0} ( 1 + {qV}^{2} )$$

where C₀, Vₘ, Q₀ and q are fitting parameter constants. The simulation results for this model is shown in FIG. 8A as well, overlayed with the actual measured results. The thickness and material composition (Ba/Sr ratio) of the BST layer 720 are primary factors in determining the tunability at a given voltage and hence Vₘ. The film quality factor Q_{BST} can be determined from low-frequency (1 MHz) impedance measurements or by extrapolating on-wafer RF data to low frequencies. The high-frequency loss of the BST capacitor 700 depends on both the loss tangent of the dielectric 720 and the conductor loss of the metal layers 710a, 710b, modeled by the series resistance R in FIG. 8B. A Q-factor can be associated with the conductor loss alone, denoted as Q_{c}, in which case the overall Q-factor of the BST capacitor 700 and the series resistance can be written as:

$$\frac{1}{{Q}_{total}} = \frac{1}{{Q}_{c}} + \frac{1}{{Q}_{BST}} and R = \frac{1}{ω {Q}_{c} C} .$$

### The series inductance L can be determined by measurement of the self-resonant frequency of the BST capacitor 700, with the stray reactive parasitic capacitance arising from on-wafer probe contacts removed.

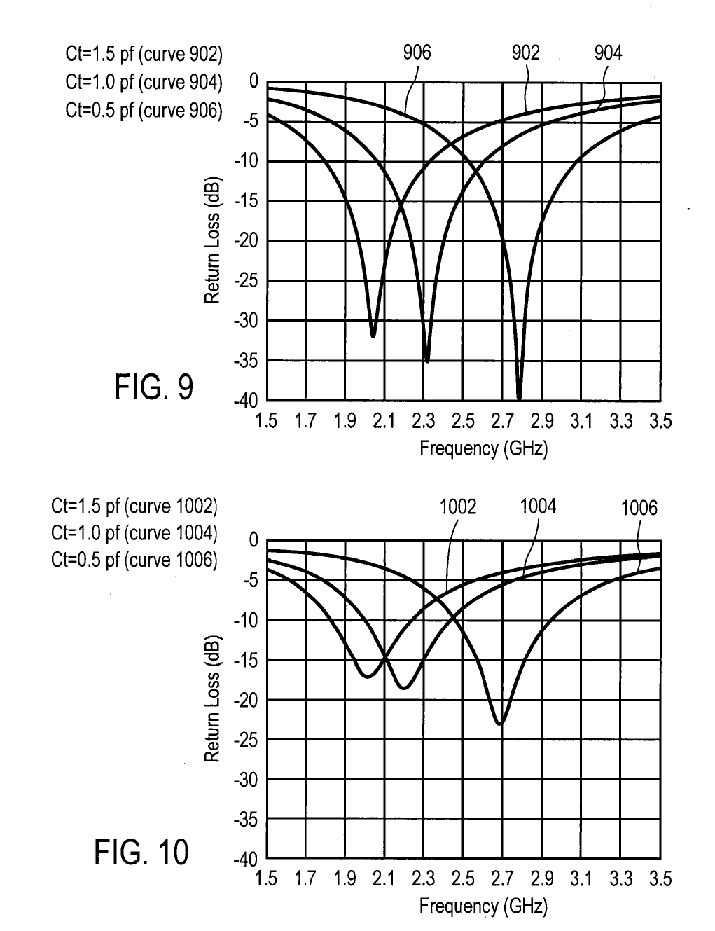

FIG. 9 illustrates the tuning range of the antenna of FIG. 4. Referring to FIGS. 4 and 9, if La1=1 nH, (Ra1+Rd1)=5 ohm, Ca1=0.2 pF, La2=10 nH, Ca2=0.8 pF, and (Ra2+Rd2)=50 ohm, a tunable capacitor Ct that has a capacitance tuning range from 1.5 pF to 0.5 pF would provide a frequency tuning range of 1.8 GHz to 3 GHz for the antenna 400 with good impedance match (return loss <−10 dB). This is shown by the curves 902, 904, 906 each corresponding to Ct=1.5 pF, Ct=1.0 pF, and Ct=0.5 pF, respectively. The insertion of the tunable capacitor Ct does not change the radiation pattern of the antenna 400 or other antenna property, but provides a good impedance match to the feed circuit and enhances the efficiency of the impedance match. This also provides more flexibility to the antenna design, i.e., the tunable component does not need to be added at the feed point of the antenna and can be inserted at a physically convenient location.

By incorporating a tunable capacitor and adjusting the structure of the antenna, the present invention has the advantage that the input impedance of the antenna may be adjusted very precisely and efficiently The added tunable component does not change the antenna's radiation pattern or directivity. The efficiency of the antenna is improved because the impedance match is better. The present invention can also be used in other antennas that require frequency tuning or impedance tuning.

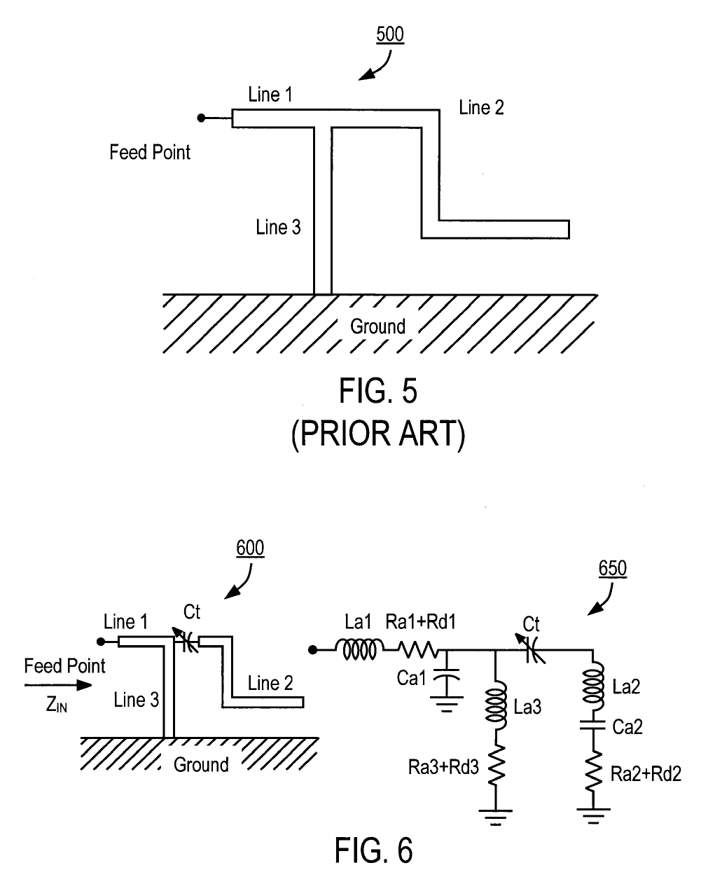

The present invention can also be used when other parasitic components exist in the antenna. FIG. 5 illustrates a conventional antenna 500 that is directly connected to ground. The antenna 500 has three sections (lines), Line 1, Line 2, and Line 3. Line 3 of the antenna 500 is directly connected to ground. Such an antenna 500 connected to ground as in FIG. 5 is a common structure, because it prevents static charges from accumulating on the antenna, which can cause ESD (Electrostatic Discharge) failure to internal electronic devices. In the antenna 500 of FIG. 5, the radiation is negligible assuming Line 1 and Line 3 are short.

FIG. 6 illustrates a tunable capacitor added inside the antenna of FIG. 5 connected to ground, according to another embodiment of the present invention. Again, the tunable capacitor Ct can be, for example, a BST capacitor using BST (Barium Strontium Titanate) as the dielectric of the capacitor, although other types of tunable capacitors may be used with the tunable antenna of the present invention.

The tunable capacitor Ct is inserted inside the antenna 600 between Line 1 and Line 2. Line 1, Line 2, and Line 3 each include inductances La1, La2, and La3, respectively. Ca1, Ca2, Ca3 are the fringe capacitance from Line 1 to ground, Line 2 to ground, and Line 3 to ground, respectively, Ra1, Ra2, Ra3 are the radiation resistance of Line 1, Line 2, Line 3, respectively, and Rd1, Rd2, Rd3 are the loss resistance of Line 1, Line 2, Line 3, respectively.

The resulting equivalent circuit 650 of the antenna 600 includes the inductance La1 and the combined resistance Ra1, Rd1 connected in series to each other, coupled to three branches in the equivalent circuit. The inductance La3 and the combined resistance Ra3, Rd3 of Line 3 forms one branch. The fringe capacitance Ca1 of Line 1 forms another branch. The tunable capacitor Ct, the inductance La2 of Line 2, the fringe capacitance Ca2 of Line 2, and the combined resistance Ra2, Rd2 coupled in series to each other form another branch. As shown in FIG. 6, the tunable capacitor Ct can be added along the metal line antenna structure (between Line 1, Line 3, and Line 2) and still achieve reasonable tuning frequency range.

FIG. 10 illustrates the tuning range of the antenna of FIG. 6. Referring to FIGS. 6 and 10, if La1=1 nH, (Ra1+Rd1)=1 ohm, Ca1=0.3 pF, La2=10 nH, Ca2=0.8 pF, (Ra2+Rd2)=50 ohm, La3=7 nH, and (Ra3+Rd3)=5 ohm, a tunable capacitor Ct that has a capacitance tuning range from 1.5 pF to 0.5 pF would provide a frequency tuning range of 1.85 GHz to 2.95 GHz for the antenna 600 with good impedance match (return loss <−10 dB). This is shown by the curves 1002, 1004, 1006 each corresponding to Ct=1.5 pF, Ct=1.0 pF, and Ct=0.5 pF, respectively. The insertion of the tunable capacitor Ct does not change the radiation pattern or other antenna property, but provides a good impedance match to the feed circuit and enhances the efficiency of the impedance match. This provides more flexibility to the design, i.e., the tunable component does not need to be added at the feed point of the antenna and can be inserted at a physically convenient location.

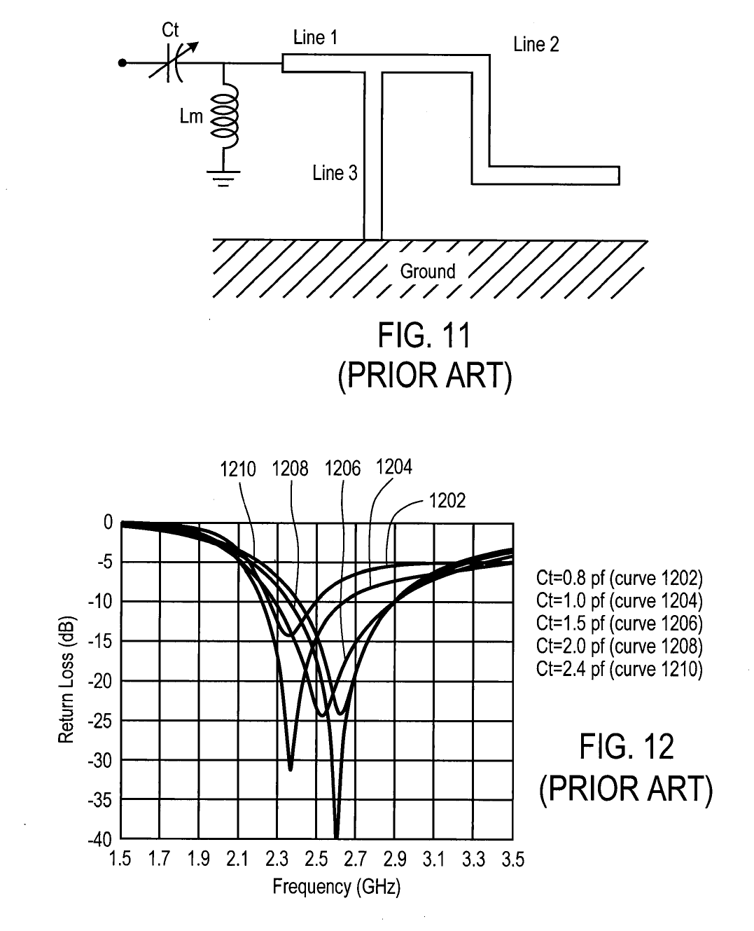

Such tunability of the antenna of the present invention can be compared to the conventional approach as follows. FIG. 11 illustrates a multiple component matching network inserted at the feed point of the antenna of FIG. 5. The impedance matching network includes the tunable capacitor Ct and the inductor Lm. Assume that the parameters of the antenna of FIG. 11 are same as those described with reference to FIGS. 6 and 10, i.e., La1=1 nH, (Ra1+Rd1)=1 ohm, Ca1=0.3 pF, La2=10 nH, Ca2=0.8 pF, (Ra2+Rd2)=50 ohm, La3=7 nH, and (Ra3+Rd3)=5 ohm.

FIG. 12 illustrates the tuning range of the antenna of FIG. 11. With a tunable capacitor Ct that can be tuned from 2.4 pF to 0.8 pF (corresponding to the curves 1202, 1204, 1206, 1208, and 1210 of FIG. 12), the operation frequency of the antenna of FIG. 11 can be tuned from 2.2 GHz to 2.9 GHz, as shown in FIG. 12. Thus, it can be seen that the frequency tuning range that can be achieved with the same tunable technology (tunable capacitors with 3:1 tunability) as in the embodiment of FIG. 6 is significantly reduced with the conventional approach of FIG. 11 (as shown in FIG. 12), compared to the tunability that can be achieved with the embodiment of FIG. 6 (as shown in FIG. 10). In addition, the extra component Lm is needed in the conventional impedance matching network for the circuit to tune to this frequency range. The additional component Lm would increase loss and cost of the tunable antenna.

Those of ordinary skill in the art will appreciate still additional alternative structural and functional designs for a tunable antenna through the disclosed principles of the present invention. For example, different types (other than a tunable capacitor) and a different number of tunable components may be added inside the antenna at different locations to obtain the tunable antenna. Thus, while particular embodiments and applications of the present invention have been illustrated and described, it is to be understood that the invention is not limited to the precise construction and components disclosed herein. Various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. An antenna, comprising:
an antenna structure for radiation and reception of a radio frequency signal; and
a tunable capacitor inserted inside the antenna structure, a capacitance of the tunable capacitor being tunable to adjust an input impedance of the antenna.

2. The antenna of claim 1, wherein the tunable capacitor is a BST (Barium Strontium Titanate) capacitor including BST dielectric, and the capacitance of the BST capacitor is tunable by adjusting a DC bias voltage applied to the BST dielectric.

3. The antenna of claim 1, wherein the tunable capacitor is placed inside the antenna structure away from both ends of the antenna structure.

4. The antenna of claim 1, wherein:
the antenna structure includes a first part, a second part, and a third part;
the first part of the antenna structure is adjacent to a feed point of the radio frequency signal to the antenna;
the second part of the antenna structure includes the tunable capacitor placed therein; and
the third part of the antenna structure includes one end coupled to both the first part of the antenna structure and the second part of the antenna structure and another end coupled to ground.

5. The antenna of claim 1, wherein the input impedance of the antenna is further adjusted by adjusting a distance between the antenna and ground.

6. A method of tuning an input impedance of an antenna, the method comprising:
adjusting a capacitance of a tunable capacitor inserted inside an antenna structure for radiation and reception of a radio frequency signal,
the input impedance of the antenna being adjusted according to the adjusted capacitance of the tunable capacitor.

7. The method of claim 6, wherein the tunable capacitor is a BST (Barium Strontium Titanate) capacitor including BST dielectric, and adjusting the capacitance of the tunable capacitor includes adjusting a DC bias voltage applied to the BST dielectric.

8. The method of claim 6, wherein the tunable capacitor is placed inside the antenna structure away from both ends of the antenna structure.

9. The method of claim 6, wherein:
the antenna structure includes a first part, a second part, and a third part;
the first part of the antenna structure is adjacent to a feed point of the radio frequency signal to the antenna;
the second part of the antenna structure includes the tunable capacitor therein; and
the third part of the antenna structure includes one end coupled to both the first part of the antenna structure and the second part of the antenna structure and another end coupled to ground.

10. The method of claim 6, further comprising adjusting a distance between the antenna and ground to further adjust the input impedance of the antenna.
